(19) United States
(12) Patent Application Publication
(10) Pub. No.: US 2024/0331374 A1
(43) Pub. Date: Oct. 3, 2024

(54) INFORMATION PROCESSING SYSTEM, INFORMATION PROCESSING METHOD, AND INFORMATION PROCESSING APPARATUS

(71) Applicant: NEC Corporation, Minato-ku, Tokyo (JP)

(72) Inventors: Yoshifumi Onishi, Tokyo (JP); Koichi Nihei, Tokyo (JP); Takanori Iwai, Tokyo (JP)

(73) Assignee: NEC Corporation, Minato-ku, Tokyo (JP)

(21) Appl. No.: 18/579,995

(22) PCT Filed: Sep. 30, 2021
(86) PCT No.: PCT/JP2021/036285

§ 371 Date: Jan. 17, 2024

(51) Int. Cl. G06V 10/98; G06V 10/25

(52) U.S. Cl. CPC G06V 10/993; G06V 10/25

(57) ABSTRACT

An information processing system (1) includes: acquisition means (11) for acquiring a coding parameter at a plurality of timings of a video image distributed via a network; and estimation means (12) for estimating reliability of results of analyzing information on a subject based on coding parameters of an area of a specific part of the subject at the plurality of timings.

### TECHNICAL FIELD

The present disclosure relates to an information processing system, an information processing method, and an information processing apparatus.

### BACKGROUND ART

Attention has been focused on techniques for collecting information detected by a sensor via a network and determining a situation of a target based on the collected information.

With regard to the above technique, Patent Literature 1 discloses a technique for analyzing biological information from representative values by excluding abnormal values (outliers) from time-series data and determining an abnormality, thereby making it possible to recognize the occurrence of the abnormality included in the measured biological information.

### CITATION LIST

### Patent Literature

[Patent Literature 1] Japanese Unexamined Patent Application Publication No. 2020-054722

### SUMMARY OF INVENTION

### Technical Problem

However, in Patent Literature 1, a problem that may be caused when an analysis is performed based on a video image that is distributed after it is coded has not been discussed. Therefore, in Patent Literature 1, when, for example, an image quality of a video image is fluctuated due to fluctuations or the like of network bandwidth, the accuracy of the analysis may be reduced.

In view of the aforementioned problem, an object of the present disclosure is to provide a technique for appropriately performing an analysis based on a video image distributed via a network.

### Solution to Problem

In a first aspect according to the present disclosure, an information processing system includes: acquisition means for acquiring coding parameters at a plurality of timings of a video image distributed via a network; and estimation means for estimating reliability of results of analyzing information on a subject based on coding parameters of an area of a specific part of the subject at the plurality of timings.

Further, in a second aspect according to the present disclosure, an information processing method executing: processing for acquiring coding parameters at a plurality of timings of a video image distributed via a network; and processing for estimating reliability of results of analyzing information on a subject based on coding parameters of an area of a specific part of the subject at the plurality of timings.

Further, in a third aspect according to the present disclosure, an information processing apparatus includes: acquisition means for acquiring coding parameters at a plurality of timings of a video image distributed via a network; and estimation means for estimating reliability of results of analyzing information on a subject based on coding parameters of an area of a specific part of the subject at the plurality of timings.

### Advantageous Effects of Invention

According to an aspect, it is possible to appropriately perform an analysis based on a video image distributed via a network.

### BRIEF DESCRIPTION OF DRAWINGS

FIG. 1A is a diagram showing one example of a configuration of an information processing system according to an example embodiment:

FIG. 1B is a diagram showing one example of a configuration of the information processing system according to the example embodiment;

FIG. 2 is a flowchart showing one example of processes of the information processing system according to the example embodiment:

FIG. 3 is a diagram showing an example of a hardware configuration of the information processing apparatus according to the example embodiment:

FIG. 4A is a diagram showing a configuration example of the information processing system according to the example embodiment:

FIG. 4B is a diagram showing a configuration example of the information processing system according to the example embodiment:

FIG. 5 is a sequence diagram showing one example of processes of the information processing system according to the example embodiment:

FIG. 6 is a diagram showing one example of a specific part DB according to the example embodiment:

FIG. 7 is a diagram showing one example of an area of a specific part according to the example embodiment:

FIG. 8 is a diagram showing one example of an analysis accuracy DB 801 according to the example embodiment; and

FIG. 9 is a diagram showing one example of analysis processing based on a video image according to the example embodiment.

### EXAMPLE EMBODIMENT

Principles of the present disclosure are described with reference to several example embodiments. It should be understood that these example embodiments are set forth for purposes of illustration only and that those skilled in the art will assist in understanding and practicing the present disclosure without suggesting limitations on the scope of the present disclosure. The disclosure described herein may be implemented in various methods other than those described below.

In the following description and claims, unless otherwise defined, all technical and scientific terms used herein have the same meaning as commonly understood by one of those skilled in the art of technology to which the present disclosure belongs.

Hereinafter, example embodiments of the present disclosure will be described with reference to the drawings.

### First Example Embodiment

### <Configuration>

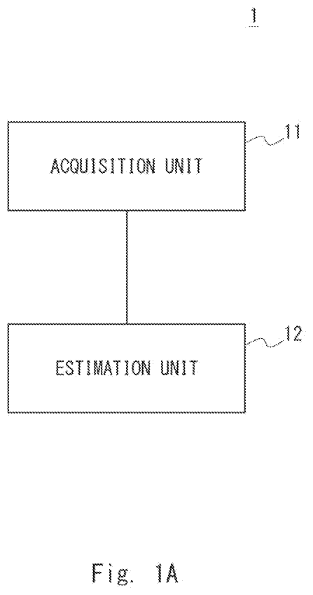

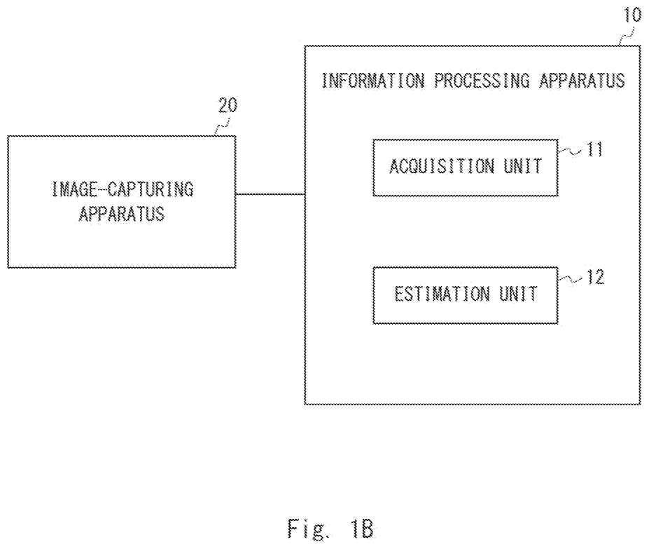

Referring to FIG. 1A, a configuration of an information processing system 1 according to an example embodiment will be described. FIG. 1A is a diagram showing one example of a configuration of the information processing system 1 according to the example embodiment. The information processing system 1 includes an acquisition unit 11 and an estimation unit 12. These units may be implemented by cooperation of one or more programs installed in an information processing apparatus 10 and hardware such as a processor 101 and a memory 102 of the information processing apparatus 10.

The acquisition unit 11 receives (acquires) various kinds of information from a storage unit inside an apparatus or an external apparatus. The acquisition unit 11 acquires, for example, a coding parameter at each timing of a video image captured by an image-capturing apparatus 20 and distributed via a network. Note that the coding parameter may include, for example, at least one of a bit rate of coding, a frame rate of coding, a quantization parameter (a QP value) of coding, or an area of each layer and a bitrate of hierarchical coding.

The estimation unit 12 estimates reliability of results of analyzing information on a subject based on the coding parameter of an area of a specific part of the subject at each timing. Note that this specific part is a part that is used to analyze, for example, an item to be analyzed (hereinafter also referred to as an “analysis target”). When, for example, a heart rate is analyzed based on a face area in a video image, the analysis target is a heart rate and the specific part is a face.

Further, the acquisition unit 11 and the estimation unit 12 may be aggregated as a single apparatus, as shown in FIG. 1B. In the example shown in FIG. 1B, the information processing system 1 includes the information processing apparatus 10 and the image-capturing apparatus 20. The image-capturing apparatus 20 is an apparatus that photographs a subject, and may be, for example, a camera built into a smartphone, a tablet or the like. Alternatively, the image-capturing apparatus 20 may be, for example, a camera connected to a personal computer or the like by an external bus. The information processing apparatus 10 includes the acquisition unit 11 and the estimation unit 12. These units may be implemented by cooperation of one or more programs installed in the information processing apparatus 10 and hardware such as a processor 101 and a memory 102 of the information processing apparatus 10.

Note that the information processing apparatus 10 may be an apparatus to which a video image captured by the image-capturing apparatus 20 and coded is distributed or may be an apparatus that distributes the video image captured by the image-capturing apparatus 20 and coded.

### <Processes>

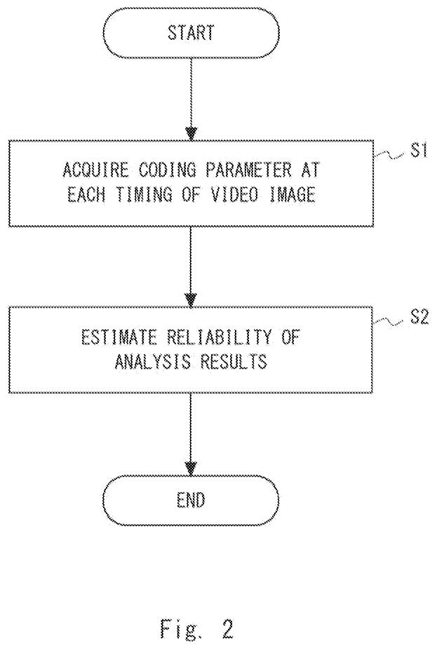

Referring next to FIG. 2, one example of processes of the information processing system 1 according to the example embodiment will be described. FIG. 2 is a flowchart showing one example of processes of the information processing system 1 according to the example embodiment.

In Step S1, the acquisition unit 11 acquires a coding parameter at each timing of a video image captured by the image-capturing apparatus 20 and distributed via a network. Next, the estimation unit 12 estimates reliability of results of analyzing the information on the subject based on the coding parameter of the area of the specific part of the subject at each timing (Step S2).

(Process Example when Information Processing Apparatus 10 is Apparatus to which Video Image is Distributed)

When the information processing apparatus 10 is an apparatus to which a video image is distributed, the estimation unit 12 receives information on the coded video image via the network N. Then the estimation unit 12 estimates reliability of results of analyzing the information on the subject based on the coding parameter of the area of the specific part of the subject at each timing.

(Process Example when Information Processing Apparatus 10 is Apparatus that Distributes Video Image)

When the information processing apparatus 10 is an apparatus that distributes a video image, the acquisition unit 11 may receive the video image from the image-capturing apparatus 20 built into the information processing apparatus 10 via an internal bus. Further, the acquisition unit 11 may receive the video image from an external (externally attached) image-capturing apparatus 20 connected to the information processing apparatus 10 by a cable or the like via an external bus. In this case, the external bus may include, for example, a Universal Serial Bus (USB) cable, a High-Definition Multimedia Interface (HDMI) (registered trademark) cable, or a Serial Digital Interface (SDI) cable. Then the estimation unit 12 estimates reliability of the results of analyzing the information on the subject based on the coding parameter of the area of the specific part of the subject at each timing.

### <Hardware Configuration>

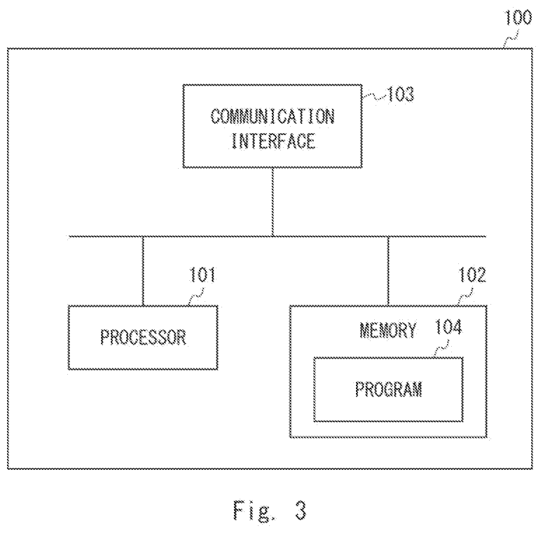

FIG. 3 is a diagram showing an example of a hardware configuration of the information processing apparatus 10 according to the example embodiment. In the example shown in FIG. 3, the information processing apparatus 10 (a computer 100) includes a processor 101, a memory 102, and a communication interface 103. These units may be connected by a bus or the like. The memory 102 stores at least a part of a program 104. The communication interface 103 includes an interface necessary for communication with other communication functions.

When the program 104 is executed by cooperation of the processor 101, the memory 102, and the like, the computer 100 performs at least a part of processing of the example embodiment of the present disclosure. The memory 102 may be of any type suitable for a local technical network. The memory 102 may be, by way of non-limiting example, a non-transitory computer readable storage medium. Further, the memory 102 may be implemented using any suitable data storage technology, such as semiconductor based memory devices, magnetic memory devices and systems, optical memory devices and systems, fixed memory and removable memory, as non-limiting examples. While only one memory 102 is shown in the computer 100, there may be several physically distinct memory modules in the computer 100. The processor 101 may be of any type. The processor 101 may include one or more of general purpose computers, special purpose computers, microprocessors, digital signal processors (DSPs) and processors based on multicore processor architecture, as non-limiting examples. The computer 100 may have multiple processors, such as an application specific integrated circuit chip that is slaved in time to a clock which synchronizes the main processor.

The example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method according to the present disclosure. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus. The program codes, when executed by the processor or controller, cause the functions/operations specified in the flowcharts and/or block diagrams to be implemented. The program code may be executed entirely on a machine, partly on the machine, as a stand-alone software package, partly on the machine and partly on a remote machine or entirely on the remote machine or server.

The program can be stored and provided to a computer using any type of non-transitory computer readable media. Non-transitory computer readable media include any type of tangible storage media. Examples of non-transitory computer readable media include magnetic storage media, optical magnetic storage media, optical disc media, semiconductor memories, etc. The magnetic storage media include, for example, flexible disks, magnetic tapes, hard disk drives, etc. The optical magnetic storage media include, for example, magneto-optical disks. The optical disc media include, for example, a Blu-ray disc, a Compact Disc (CD)-Read Only Memory (ROM), CD-Recordable (R), CD-ReWritable (RW), etc. The semiconductor memories include, for example, solid state drive, mask ROM, Programmable ROM (PROM), Erasable PROM (EPROM), flash ROM, random access memory (RAM), etc. The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

### Second Example Embodiment

### <System Configuration>

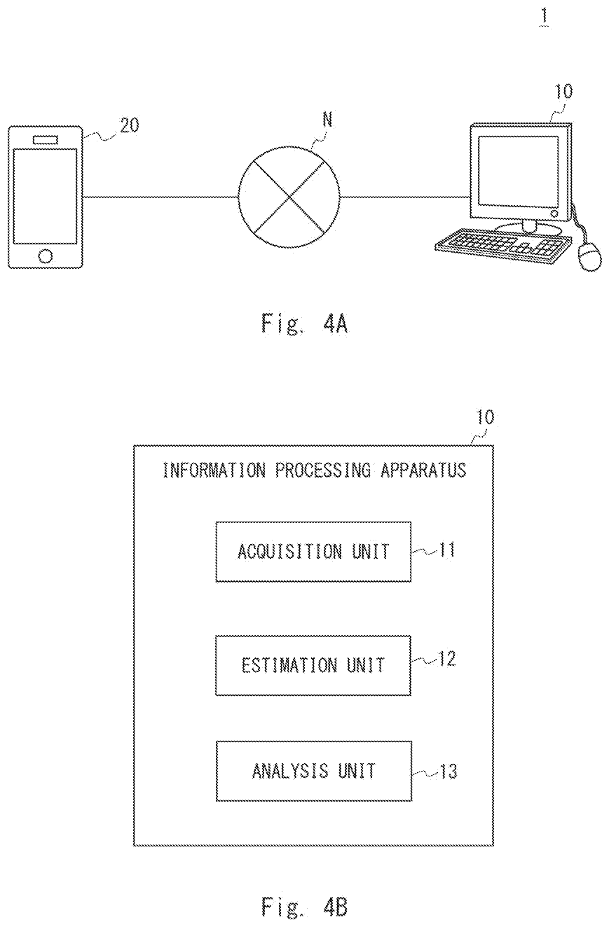

Referring next to FIGS. 4A and 4B, one example of a configuration of an information processing system 1 according to an example embodiment will be described. FIG. 4A is a diagram showing a configuration example of the information processing system 1 according to the example embodiment. In the example shown in FIG. 4A, the information processing system 1 includes an image-capturing apparatus 20 and an information processing apparatus 10. Note that the number of image-capturing apparatuses 20 and the number of information processing apparatuses 10 are not limited to those shown in the example in FIG. 4A.

Note that the technique according to the present disclosure may be used, for example, for measurement of biological information based on a video image of a patient (a human being or an animal) in a video conference (a video call or an online medical examination) between a doctor and the patient. The technique according to the present disclosure may also be used, for example, for analysis (specification) of a person and analysis (estimation) of behavior based on video images in a monitoring camera. The technique according to the present disclosure may also be used, for example, for analysis (testing) of a product based on video images of a monitoring camera installed in a factory or a plant.

In the example shown in FIG. 4A, the image-capturing apparatus 20 and the information processing apparatus 10 are connected to each other in such a way that they can communicate with each other via a network N. The network N includes, for example, the Internet, a mobile communication system, wireless Local Area Network (LAN), Wi-Fi (registered trademark), LAN, a short-range wireless communication such as Bluetooth (registered trademark) Low Energy (BLE), and the like. The mobile communication system includes, for example, the fifth generation mobile communication system (5G), local 5G, Beyond 5G (6G), the fourth generation mobile communication system (4G), Long Term Evolution (LTE), the third generation mobile communication system (3G), and the like.

The image-capturing apparatus 20 may be, for example, an apparatus such as a smartphone, a tablet, a personal computer or the like. The image-capturing apparatus 20 codes a captured video image by any coding scheme and distributes the coded video image to the information processing apparatus 10 via the network N. This coding scheme may include, for example, H.265/High Efficiency Video Coding (HEVC), AO Media Video 1 (AV1), H.264/MPEG-4 Advanced Video Coding (AVC), and the like.

The information processing apparatus 10 may be, for example, an apparatus such as a personal computer, a server, a cloud, a smartphone, or a tablet. The information processing apparatus 10 performs an analysis based on the video image distributed from the image-capturing apparatus 20.

FIG. 4B shows a diagram showing one example of a configuration of the information processing apparatus 10 according to the example embodiment. The example shown in FIG. 4B is different from the example shown in FIG. 1 in that the information processing apparatus 10 further includes an analysis unit 13 in the example shown in FIG. 4B. The analysis unit 13 may be implemented by cooperation of one or more programs installed in the information processing apparatus 10 and hardware such as a processor 101 and a memory 102 of the information processing apparatus 10. The analysis unit 13 calculates information on the subject based on the reliability estimated by the estimation unit 12 and the video image of the area of the specific part. Note that at least some of the processes for this calculation may be executed by an external device such as a cloud. In this case, the analysis unit 13 may transmit the video image to this external apparatus and acquire results of the processing in the external apparatus from the external apparatus.

(Process Example when Information Processing Apparatus 10 is Apparatus to which

Video Image is Distributed) When the information processing apparatus 10 is an apparatus to which a video image is distributed and an analysis based on the video image is executed by an external apparatus such as a cloud, the analysis unit 13 may forward the distributed video image to the external apparatus and acquire results of the processing in the external apparatus from the external apparatus. Further, when an analysis based on the video image and reliability estimated based on a coding parameter is executed by an external apparatus such as a cloud, the analysis unit 13 may forward the distributed video image and the estimated reliability to the external apparatus and acquire the results of the processing in the external apparatus from the external apparatus.

(Process Example when Information Processing Apparatus 10 is Apparatus that Distributes Video Image)

When the information processing apparatus 10 is an apparatus that distributes the video image and an analysis based on the video image is executed by an external apparatus such as a cloud or a distribution destination apparatus, the analysis unit 13 may distribute the video image coded by a module or the like that performs coding processing inside the information processing apparatus 10 to the external apparatus and acquire results of the processing in the external apparatus from the external apparatus. Further, when the analysis based on the video image and the reliability estimated based on the coding parameter is executed by an external apparatus such as a cloud, the analysis unit 13 may forward the distributed video image and the estimated reliability to the external apparatus and acquire results of the processing in the external apparatus from the external apparatus.

### <Processes>

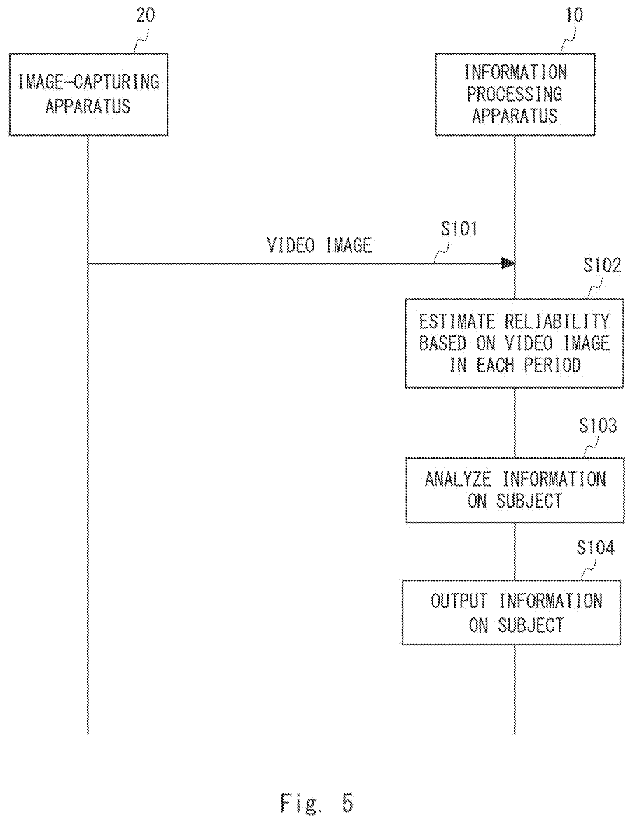

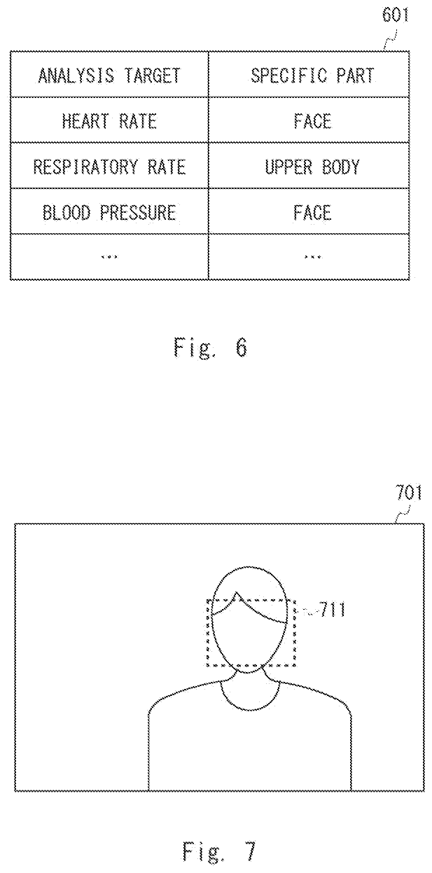

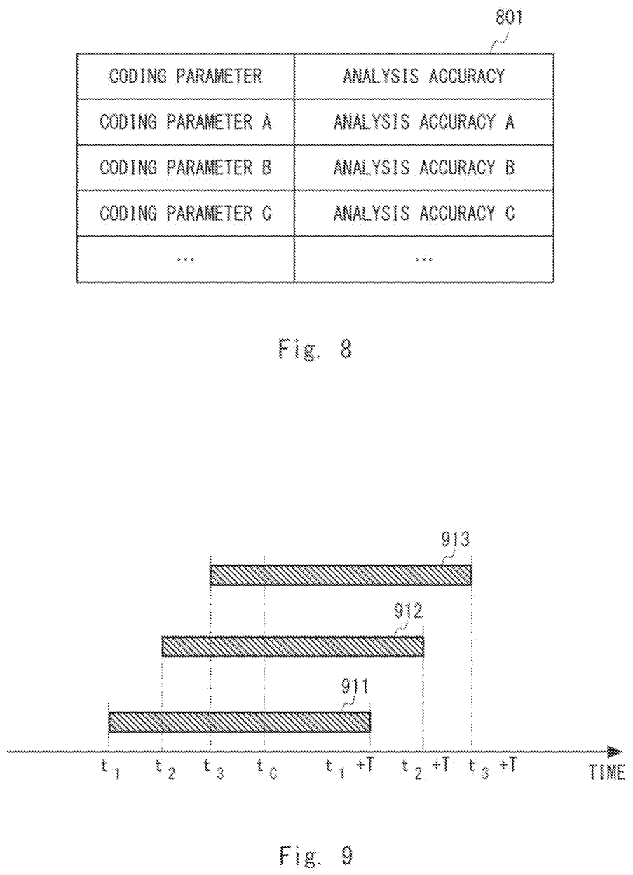

Referring next to FIGS. 5 to 7, one example of processes of the information processing system 1 according to the example embodiment will be described. FIG. 5 is a sequence diagram showing one example of processes of the information processing system 1 according to the example embodiment. FIG. 6 is a diagram showing one example of a specific part database (DB) 601 according to the example embodiment. FIG. 7 is a diagram showing one example of an area of a specific part according to the example embodiment. FIG. 8 is a diagram showing one example of an analysis accuracy DB 801 according to the example embodiment. FIG. 9 is a diagram showing one example of analysis processing based on a video image according to the example embodiment.

Hereinafter, as one example, a case where biological information based on a patient's video image is measured in a video conference (a video call or an online medical examination) between a doctor and the patient will be described. Further, in the following description, as one example, a case where the information processing apparatus 10 is a terminal held by a doctor, the terminal being an apparatus to which a video image is distributed, will be described. In the following description, it is assumed that a process of establishing a video conference session or the like between the image-capturing apparatus 20 of the patient and the information processing apparatus 10 of the doctor has already been ended.

In Step S101, the image-capturing apparatus 20 codes the video image captured by the image-capturing apparatus 20 and distributes (transmits) the coded video image to the information processing apparatus 10 via the network N. The image-capturing apparatus 20 changes and codes the image quality in accordance with a fluctuation of the bandwidth or the like that can be used in the network N. In this case, the image-capturing apparatus 20 may acquire, for example, information such as packet loss numbers, jitter, or the like that indicates the communication quality of the network N at each timing from the information processing apparatus 10 or an external apparatus or system other than the image-capturing apparatus 20 and the information processing apparatus 10 using Real-time Transport Protocol (RTP) Control Protocol (RTCP) or the like. The image-capturing apparatus 20 may then determine a coding parameter such as a bitrate at each timing based on the information indicating the communication quality of the network N at each timing. In this case, the image-capturing apparatus 20 may determine, for example, a coding parameter which makes the image quality higher as the communication quality of the network N becomes higher.

The image-capturing apparatus 20 may code each frame of a video image using, for example, a map (a QP map) that sets a quantization parameter (QP value) of coding by a unit of a specific pixel area (e.g., 16 pixels (height)×16 pixels (width)). Further, the image-capturing apparatus 20 may code each frame of the video image using, for example, hierarchical coding (SVC, Scalable Video Coding) as a coding scheme.

Next, the estimation unit 12 of the information processing apparatus 10 estimates (calculates or determines), based on the coding parameter of the area of the specific part in the video image in each period, reliability of the analysis results which are based on the video image in each period (hereinafter, this reliability is also referred to as a “first reliability”) (Step S102). Note that the first reliability, which is specified according to a coding parameter, is a value indicating certainty of the analysis results obtained when an analysis based on a video image is performed.

The estimation unit 12 of the information processing apparatus 10 may calculate the first reliability of the analysis results which are based on the video image in each period based on the coding parameter of the area of the specific part of the subject at each timing. In this case, the estimation unit 12 of the information processing apparatus 10 may extract, for example, information on the specific part (area of interest) according to the analysis target by referring to the specific part DB 601. The specific part DB 601 may be stored (registered or set) in a storage apparatus provided inside the information processing apparatus 10 or may be stored in a DB server or the like provided in the outside of the information processing apparatus 10. In the example shown in FIG. 6, a specific part is recorded in the specific part DB 601 in such a way that the specific part is associated with the analysis target. In the example shown in FIG. 6, it is specified, for example, that the video image of the face area of the subject is used when the heart rate is analyzed. Note that the analysis target may be specified (selected or set) in advance by a doctor or the like who uses the information processing apparatus 10. The phrase “in advance” may be any timing before Step S102 is executed. In this case, the information processing apparatus 10 may be specified (selected) by the doctor from a list of items of the biological information, which are analysis targets. Further, the analysis target may be specified by the information processing apparatus 10 based on results of a medical history form filled out by a patient in advance (before this patient is examined by the doctor) on a predetermined website or the like. In the example shown in FIG. 7, a face area 711 of the patient of a frame 701 of the video image is used for estimation as the specific part.

Note that the above specific part may be specified, for example, by a doctor. In this case, the distribution destination apparatus 30 may be specified, for example, by an operation or the like of surrounding a specific part of the patient by dragging this part by a mouse or the like on a display screen of the video image of the patient. Further, the distribution destination apparatus 30 may be specified (selected) by a doctor from a list of specific parts of the subject.

Then, the estimation unit 12 of the information processing apparatus 10 may determine, for example, the first reliability to be higher as the image quality of the area of the specific part at each timing included in the period becomes higher. This image quality may include, for example, an image quality which is based on at least one of a bit rate of coding, a frame rate of coding, or a QP value of coding. Further, the estimation unit 12 of the information processing apparatus 10 may determine, for example, the first reliability to be lower as a change in the image quality of the area of the specific part at each timing included in the period becomes larger. This is because, for example, when a bitrate or the like of the area of the specific part has been suddenly increased or suddenly decreased, noise occurs in a decoded video image, which may cause a degradation in the accuracy of the analysis by AI or the like.

In this case, the estimation unit 12 of the information processing apparatus 10 may calculate the first reliability of the analysis results which are based on a video image 911 based on, for example, a weighted average where a weight of a time length, which is each image quality, is added to the value of the analysis accuracy in accordance with the image quality at each timing, and a value in accordance with the change in the image quality. It is assumed, for example, that the image quality of the area of the specific part has been changed from a first image quality to a second image quality due to a change in the coding parameter at time the in FIG. 9. In this case, the first reliability E₁ of the analysis results which are based on a video image 911 may be calculated as shown in the following Expression (1).

$${E}_{1} = \{ {Q}_{1} \times ( {t}_{c} - {t}_{1} ) + {Q}_{2} \times ( {t}_{1} + T - {t}_{c} ) \} / T - {Q}_{3} \qquad ( 1 )$$

In Expression (1), a value Q₃ in accordance with the change from the first image quality to the second image quality is subtracted from a weighted average value where a weight in accordance with a time length from time t₁ to time the is added to a value Q₁ in accordance with the first image quality and a weight in accordance with a time length from time the t_{c} time t₁+T is added to a value Q₂ in accordance with the second image quality. Note that the value Q₁ in accordance with the first image quality, the value Q₂ in accordance with the second image quality, and the value Q₃ in accordance with the change from the first image quality to the second image quality may be set (registered) in advance in the analysis accuracy DB 801 or the like shown in FIG. 8 or may be calculated by AI or the like. In the example shown in FIG. 8, the value of the analysis accuracy is set in advance in the analysis accuracy DB 801 in such a way that the value of the analysis accuracy is associated with the coding parameter. Note that the analysis accuracy DB 801 may be stored (registered or set) in a storage apparatus provided inside the information processing apparatus 10 or may be stored in an a DB server or the like provided in the outside of the information processing apparatus 10.

Next, the analysis unit 13 of the information processing apparatus 10 analyzes information on the subject based on the estimated first reliability and the received video image in each period (Step S103). Here, the analysis unit 13 of the information processing apparatus 10 may analyze information on the subject based on the first reliability and the video image by, for example, Artificial Intelligence (AI) that uses deep learning.

Further, the analysis unit 13 of the information processing apparatus 10 may analyze, for example, information on the subject based on the video image by AI that uses deep learning or the like, and correct the analysis results based on the analysis results which are based on the video image and the first reliability. In this case, the analysis unit 13 of the information processing apparatus 10 may first extract, for example, from the received video image, a plurality of video images having a specific period length with different start points, and execute estimation of the biological information or the like by AI or the like based on the plurality of extracted video images. Note that the specific period length may be set in advance. Alternatively, this specific period length may be determined in accordance with the first reliability calculated in Step S102. In this case, this specific period length may be determined to be longer as the value of the first reliability becomes smaller. In the example shown in FIG. 9, based on each of the video image 911 in the period from time t₁ to the specific period length T, a video image 912 in the period from time t₂ to the specific period length T, and a video image 913 in the period from time t₃ to the specific period length T, the analysis results and the second reliability of the analysis results are calculated. Note that the second reliability is information indicating certainty (probability) of each of the analysis results calculated by deep learning or the like based on the video image or the like. Note that the second reliability may be calculated based on movements of the subject, the magnitude of the frequency peak of the color change, or the like.

When at least one of the first reliability or the second reliability for one period is equal to or smaller than a threshold, the analysis unit 13 of the information processing apparatus 10 may not use analysis results which are based on the video image in this period. In this case, the analysis unit 13 of the information processing apparatus 10 may perform an analysis which is based on a video image in a period in which at least one of the first reliability or the second reliability is not equal to or smaller than the threshold, not based on the video image in the aforementioned period. In this case, when, for example, at least one of the first reliability or the second reliability for a period from time t₁ is equal to or smaller than the threshold, the analysis unit 13 of the information processing apparatus 10 may calculate the first reliability based on a coding parameter at each timing in a period from time t4 to the specific period length T. Then, the analysis unit 13 of the information processing apparatus 10 may perform an analysis based on a video image in a period from time t4 to the specific period length T and the first reliability.

The biological information, which is an analysis target, may include, for example, at least one of a heart rate, a respiratory rate, blood pressure, swelling, transcutaneous arterial blood oxygen saturation, a pupil size, throat swelling, or a degree of periodontal disease.

The analysis unit 13 of the information processing apparatus 10 may estimate a heart rate based on a video image of an area where the patient's skin is exposed (e.g., face area). In this case, the analysis unit 13 of the information processing apparatus 10 may estimate the heart rate based on, for example, transition (period) of changes in the skin color.

Further, the analysis unit 13 of the information processing apparatus 10 may estimate a respiratory rate based on a video image of an area of the patient's chest (upper body). In this case, the analysis unit 13 of the information processing apparatus 10 may estimate the respiratory rate based on, for example, a cycle of shoulder movements.

Further, the analysis unit 13 of the information processing apparatus 10 may estimate blood pressure based on the video image of the area where the patient's skin is exposed (e.g., face area). In this case, the analysis unit 13 of the information processing apparatus 10 may estimate the blood pressure based on, for example, the difference between pulse waves estimated from two parts of the face (e.g., forehead and cheeks) and the shapes of these pulse waves.

Further, the analysis unit 13 of the information processing apparatus 10 may estimate transcutaneous arterial blood oxygen saturation (SpO2) based on the video image of the area where the patient's skin is exposed (e.g., face area). Note that red is easily transmitted when hemoglobin is bonded to oxygen, while blue is insusceptible to the binding of hemoglobin to oxygen. Therefore, the analysis unit 13 of the information processing apparatus 10 may estimate SpO2 based on, for example, the difference in the degree of change in the blue color and red color of the skin near the cheekbones under the eyes.

Further, the analysis unit 13 of the information processing apparatus 10 may estimate, for example, a degree of swelling based on a video image of the patient's eyelid area. Further, the analysis unit 13 of the information processing apparatus 10 may estimate, for example, a pupil size (pupil diameter) based on a video image of the patient's eye area. Further, the analysis unit 13 of the information processing apparatus 10 may estimate, for example, throat swelling, a degree of periodontal disease, or the like based on a video image of the patient's mouth area.

Then, the analysis unit 13 of the information processing apparatus 10 may correct (update or change), for example, the value of the second reliability of the analysis results which are based on the video image in each period calculated by AI or the like based on the first reliability calculated in Step S102. In this case, the analysis unit 13 of the information processing apparatus 10 may calculate, for example, a value E₂′ of the reliability after the correction of the analysis results which are based on the video image 911 as shown in the following Expression (2). Note that E₂ is a value of the second reliability.

$${E}_{2}^{′} = {E}_{1} \times {E}_{2} \qquad ( 2 )$$

Then, the analysis unit 13 of the information processing apparatus 10 may determine a weighted average or the like where a weight of reliability of each of analysis results is added to each of analysis results as a value of the biological information. It is assumed, for example, that the estimated value of the heart rate based on the video image 911 is 83, the reliability after the correction is 0.8, the estimated value of the heart rate based on the video image 912 is 85, the reliability after the correction is 0.7, the estimated value of the heart rate based on the video image 913 is 90, and the reliability after the correction is 0.7. In this case, for example, the heart rate is calculated as (83×0.8+85×0.7+90×0.7)/(0.8+0.7+0.7)=86.

Next, the analysis unit 13 of the information processing apparatus 10 outputs the calculated biological information or the like of the subject (Step S104). Note that the analysis unit 13 of the information processing apparatus 10 may cause the biological information on the patient to be displayed on a display device.

(Example in which Person is Specified by Using Video Image of Image-Capturing Apparatus 20, which is Monitoring Camera)

In the aforementioned example, the example of measuring biological information in a video conference between a doctor and a patient has been described. In the following description, an example in which a person is specified by using a video image of the image-capturing apparatus 20, which is a monitoring camera, will be described. In this case, a video image of the image-capturing apparatus 20 may be distributed from the image-capturing apparatus 20 to the information processing apparatus 10.

The analysis unit 13 of the information processing apparatus 10 may specify the person, who is the subject, based on a video image of a face area of a person at each timing and a coding parameter of the face area of the person at each timing. Further, the analysis unit 13 of the information processing apparatus 10 may specify behavior of the person, who is the subject, based on a video image of the area of the whole body of the person at each timing and a coding parameter of the area of the whole body of the person at each timing.

(Example in which Product is Tested (Inspected) by Video Image of Image-Capturing Apparatus 20)

In the following description, an example in which a product is tested (inspected) by a video image of an image-capturing apparatus 20, which is a monitoring camera, will be described. In this case, a video image of the image-capturing apparatus 20 may be distributed from the image-capturing apparatus 20 to the information processing apparatus 10. The analysis unit 13 of the information processing apparatus 10 may test the product based on the video image of the area of the product at each timing and a coding parameter of the area of the product at each timing.

(Example in which Facility is Checked by Using Video Image of Image-Capturing Apparatus 20)

In the following description, an example in which a facility is checked by using a video image of an image-capturing apparatus 20 mounted on a drone, a robot that autonomously moves on the ground, or the like will be described. In this case, a video image of the image-capturing apparatus 20 may be distributed from the image-capturing apparatus 20 mounted on the drone or the like to the information processing apparatus 10. The analysis unit 13 of the information processing apparatus 10 may test a part to be checked (e.g., an insulator) (e.g., measurement of a damage or a degradation level) based on the video image of the area of the part to be checked at each timing and a coding parameter of the area of the part to be checked at each timing.

### Modified Examples

While the information processing apparatus 10 may be an apparatus included in one housing, the information processing apparatus 10 according to the present disclosure is not limited to this example. Each unit of the information processing apparatus 10 may be implemented, for example, by cloud computing constituted by one or more computers. Further, at least some the processes of the information processing apparatus 10 may be implemented, for example, by another information processing apparatus 10. Such an information processing apparatus 10 is also included in one example of the “information processing apparatus” according to the present disclosure.

Note that the present disclosure is not limited to the aforementioned example embodiments and may be changed as appropriate without departing from the spirit of the present disclosure.

The whole or part of the example embodiments disclosed above can be described as, but not limited to, the following supplementary notes.

### (Supplementary Note 1)

An information processing system comprising:
acquisition means for acquiring coding parameters at a plurality of timings of a video image distributed via a network; and
estimation means for estimating reliability of results of analyzing information on a subject based on coding parameters of an area of a specific part of the subject at the plurality of timings.

### (Supplementary Note 2)

The information processing system according to Supplementary Note 1, wherein
the information processing system includes analysis means,
the estimation means estimates the reliability in a period including the plurality of timings based on the coding parameters at the plurality of timings, and
the analysis means calculates information on the subject based on the reliability estimated by the estimation means and the video image of the area of the specific part in the period.

### (Supplementary Note 3)

The information processing system according to Supplementary Note 2, wherein the estimation means estimates the reliability in the period based on a first coding parameter at a first timing included in the period and a second coding parameter at a second timing included in the period.

### (Supplementary Note 4)

The information processing system according to Supplementary Note 3, wherein the estimation means determines the reliability in the period to become smaller as an amount of change between the first coding parameter and the second coding parameter becomes larger.

### (Supplementary Note 5)

The information processing system according to any one of Supplementary Notes 2 to 4, wherein the analysis means applies a weight in accordance with the reliability in the period on each of the values of the results of analyzing information on the subject based on the video image in the period, and estimates information on the subject based on a total value of the weighted values.

### (Supplementary Note 6)

The information processing system according to any one of Supplementary Notes 1 to 5, wherein coding parameters at the plurality of timings include at least one of a bit rate of coding, a frame rate of coding, a quantization parameter of coding, or an area of each layer and a bitrate of hierarchical coding.

### (Supplementary Note 7)

An information processing method executing:
processing for acquiring coding parameters at a plurality of timings of a video image distributed via a network; and
processing for estimating reliability of results of analyzing information on a subject based on coding parameters of an area of a specific part of the subject at the plurality of timings.

### (Supplementary Note 8)

The information processing method according to Supplementary Note 7, wherein
the information processing method comprises analyzing processing, in the estimating processing, the reliability in a period including the plurality of timings is estimated based on the coding parameters at the plurality of timings, and
in the analyzing processing, information on the subject is calculated based on the reliability estimated in the estimating processing and the video image of the area of the specific part in the period.

### (Supplementary Note 9)

The information processing method according to Supplementary Note 8, wherein, in the estimating processing, the reliability in the period is estimated based on a first coding parameter at a first timing included in the period and a second coding parameter at a second timing included in the period.

### (Supplementary Note 10)

The information processing method according to Supplementary Note 9, wherein, in the estimating processing, the reliability in the period is determined to become smaller as an amount of change between the first coding parameter and the second coding parameter becomes larger.

### (Supplementary Note 11)

The information processing method according to any one of Supplementary Notes 8 to 10, wherein, in the analyzing processing, a weight in accordance with the reliability in the period is applied on each of the values of the results of analyzing information on the subject based on the video image in the period, and information on the subject is estimated based on a total value of the weighted values.

### (Supplementary Note 12)

The information processing method according to any one of Supplementary Notes 7 to 11, wherein coding parameters at the plurality of timings include at least one of a bit rate of coding, a frame rate of coding, a quantization parameter of coding, or an area of each layer and a bitrate of hierarchical coding.

### (Supplementary Note 13)

An information processing apparatus comprising:
acquisition means for acquiring coding parameters at a plurality of timings of a video image distributed via a network; and
estimation means for estimating reliability of results of analyzing information on a subject based on coding parameters of an area of a specific part of the subject at the plurality of timings.

### (Supplementary Note 14)

The information processing apparatus according to Supplementary Note 13, wherein
the information processing apparatus includes analysis means,
the estimation means estimates the reliability in a period including the plurality of timings based on the coding parameters at the plurality of timings, and
the analysis means calculates information on the subject based on the reliability estimated by the estimation means and the video image of the area of the specific part in the period.

### (Supplementary Note 15)

The information processing apparatus according to Supplementary Note 14, wherein the estimation means estimates the reliability in the period based on a first coding parameter at a first timing included in the period and a second coding parameter at a second timing included in the period.

### (Supplementary Note 16)

The information processing apparatus according to Supplementary Note 15, wherein the estimation means determines the reliability in the period to become smaller as an amount of change between the first coding parameter and the second coding parameter becomes larger.

### (Supplementary Note 17)

The information processing apparatus according to any one of Supplementary Notes 14 to 16, wherein the analysis means applies a weight in accordance with the reliability in the period on each of the values of the results of analyzing information on the subject based on the video image in the period, and estimates information on the subject based on a total value of the weighted values.

### (Supplementary Note 18)

The information processing apparatus according to any one of Supplementary Notes 13 to 17, wherein coding parameters at the plurality of timings include at least one of a bit rate of coding, a frame rate of coding, a quantization parameter of coding, or an area of each layer and a bitrate of hierarchical coding.

### REFERENCE SIGNS LIST

1 INFORMATION PROCESSING SYSTEM
10 INFORMATION PROCESSING APPARATUS
10A INFORMATION PROCESSING APPARATUS
10B INFORMATION PROCESSING APPARATUS
11 ACQUISITION UNIT
12 ESTIMATION UNIT
13 ANALYSIS UNIT
20 IMAGE-CAPTURING APPARATUS
N NETWORK

What is claimed is:

1. An information processing system comprising:
at least one memory storing instructions, and
at least one processor configured to execute the instructions to;
acquire coding parameters at a plurality of timings of a video image distributed via a network; and
estimate reliability of results of analyzing information on a subject based on coding parameters of an area of a specific part of the subject at the plurality of timings.

2. The information processing system according to claim 1, wherein
the at least one processor is configured to estimate the reliability in a period including the plurality of timings based on the coding parameters at the plurality of timings, and
the at least one processor is configured to calculate information on the subject based on the estimated reliability and the video image of the area of the specific part in the period.

3. The information processing system according to claim 2, wherein the at least one processor is configured to estimate the reliability in the period based on a first coding parameter at a first timing included in the period and a second coding parameter at a second timing included in the period.

4. The information processing system according to claim 3, wherein the at least one processor is configured to determine the reliability in the period to become smaller as an amount of change between the first coding parameter and the second coding parameter becomes larger.

5. The information processing system according to claim 2 4, wherein the at least one processor is configured to apply a weight in accordance with the reliability in the period on each of the values of the results of analyzing information on the subject based on the video image in the period, and estimates information on the subject based on a total value of the weighted values.

6. The information processing system according to claim 1, wherein coding parameters at the plurality of timings include at least one of a bit rate of coding, a frame rate of coding, a quantization parameter of coding, or an area of each layer and a bitrate of hierarchical coding.

7. An information processing method executing:
processing for acquiring coding parameters at a plurality of timings of a video image distributed via a network; and
processing for estimating reliability of results of analyzing information on a subject based on coding parameters of an area of a specific part of the subject at the plurality of timings.

8. The information processing method according to claim 7, wherein
the information processing method comprises analyzing processing,
in the estimating processing, the reliability in a period including the plurality of timings is estimated based on the coding parameters at the plurality of timings, and
in the analyzing processing, information on the subject is calculated based on the reliability estimated in the estimating processing and the video image of the area of the specific part in the period.

9. The information processing method according to claim 8, wherein, in the estimating processing, the reliability in the period is estimated based on a first coding parameter at a first timing included in the period and a second coding parameter at a second timing included in the period.

10. The information processing method according to claim 9, wherein, in the estimating processing, the reliability in the period is determined to become smaller as an amount of change between the first coding parameter and the second coding parameter becomes larger.

11. The information processing method according to claim 8, wherein, in the analyzing processing, a weight in accordance with the reliability in the period is applied on each of the values of the results of analyzing information on the subject based on the video image in the period, and information on the subject is estimated based on a total value of the weighted values.

12. The information processing method according to claim 7, wherein coding parameters at the plurality of timings include at least one of a bit rate of coding, a frame rate of coding, a quantization parameter of coding, or an area of each layer and a bitrate of hierarchical coding.

13. An information processing apparatus comprising:
at least one memory storing instructions, and
at least one processor configured to execute the instructions to;
acquire coding parameters at a plurality of timings of a video image distributed via a network; and
estimate reliability of results of analyzing information on a subject based on coding parameters of an area of a specific part of the subject at the plurality of timings.

14. The information processing apparatus according to claim 13, wherein
the at least one processor is configured to estimate the reliability in a period including the plurality of timings based on the coding parameters at the plurality of timings, and
the at least one processor is configured to calculate information on the subject based on the estimated reliability and the video image of the area of the specific part in the period.

15. The information processing apparatus according to claim 14, wherein the at least one processor is configured to estimate the reliability in the period based on a first coding parameter at a first timing included in the period and a second coding parameter at a second timing included in the period.

16. The information processing apparatus according to claim 15, wherein the at least one processor is configured to determine the reliability in the period to become smaller as an amount of change between the first coding parameter and the second coding parameter becomes larger.

17. The information processing apparatus according to claim 14, wherein the at least one processor is configured to apply a weight in accordance with the reliability in the period on each of the values of the results of analyzing information on the subject based on the video image in the period, and estimates information on the subject based on a total value of the weighted values.

18. The information processing apparatus according to claim 13, wherein coding parameters at the plurality of timings include at least one of a bit rate of coding, a frame rate of coding, a quantization parameter of coding, or an area of each layer and a bitrate of hierarchical coding.
